(19) United States
(12) Patent Application Publication
(10) Pub. No.: US 2013/0089060 A1
(43) Pub. Date: Apr. 11, 2013

(54) RADIO BASE STATION AND POWER SUPPLY CONTROL METHOD

(71) Applicants: Mitsuhiro Kitaji, Yokohama-shi (JP); Kenta Okino, Yokohama-shi (JP); Masato Fujishiro, Yokohama-shi (JP); Chiharu Yamazaki, Ota-ku (JP)

(72) Inventors: Mitsuhiro Kitaji, Yokohama-shi (JP); Kenta Okino, Yokohama-shi (JP); Masato Fujishiro, Yokohama-shi (JP); Chiharu Yamazaki, Ota-ku (JP)

(73) Assignee: KYOCERA CORPORATION, Kyoto (JP)

(21) Appl. No.: 13/704,943

(22) PCT Filed: Jun. 15, 2011
(86) PCT No.: PCT/JP2011/063692

§ 371 Date: Dec. 17, 2012

(30) Foreign Application Priority Data
Jun. 18, 2010 (JP) 2010-140008

(51) Int. Cl. H04W 52/02

(52) U.S. Cl. CPC H04W 52/0212
USPC 370/329

(57) ABSTRACT

If an unallocated PDSCH exists upon allocating downlink resource blocks to the radio terminal UE30-1, a radio base station eNB10-1 identifies a period corresponding to an area of the unallocated PDSCH (PDSCH unallocated period), and turns off a power amplifier 112 in the PDSCH unallocated period.

### TECHNICAL FIELD

The present invention relates to a radio communication technique, and particularly relates to a radio base station and a power supply control method which employ SON.

### BACKGROUND ART

Technology called SON (Self Organizing Network) is employed in LTE (Long Term Evolution) which is standardized by the 3GPP (3rd Generation Partnership Project) as a standardization organization for radio communication system. SON is expected to automate setting and maintenance of a radio base station without requiring human intervention for measurement and settings in the field (see Non-patent Literature 1, for example).

SON proposes a method of reducing the power consumption of a radio base station (termed as “eNB” in the 3GPP) by controlling the turn-on and turn-off of the radio base station. Such a method is called energy savings. In the energy savings, when a radio base station eNB is turned on, the radio base station eNB notifies a different radio base station eNB of this fact; meanwhile, when a radio base station eNB turns a different radio base station on, the radio base station eNB notifies the different radio base station of this fact.

However, the above method of the energy savings cannot meet the demand for improving the efficiency of a radio base station eNB by reducing the power consumption of the radio base station eNB as much as possible even when it is in operation.

### CITATION LIST

### Non-Patent Literature

Non-Patent Literature 1: 3GPP TR 36.902 V9.1.0, March 2010

### SUMMARY OF THE INVENTION

A radio base station (radio base station eNB10-1) according to a first feature, in a radio communication system (radio communication system 1) having a plurality of radio resources corresponding to different periods, allocates the radio resources to a radio terminal (radio terminal UE30-1). The radio base station comprises: a transmitter (radio communication unit 110) sending, to the radio terminal, a radio signal using the allocated radio resources; and a controller (power supply controller 123) controlling a power supply of the transmitter. The controller turns off the transmitter in a period corresponding to an unallocated radio resource among the radio resources.

According to the above feature, the controller is capable of turning off the transmitter in a period corresponding to an unallocated radio resource, i.e., a period where no radio communication is performed between the radio base station and the radio terminal. This enables efficient power supply control.

The feature of the present invention is summarized as follows. The radio resources include a control area (PDCCH) for control data and a data area (PDSCH) for user data which are arranged in a time direction, and the controller turns off the transmitter in the period corresponding to an unallocated data area among the data areas of the radio resources.

In the first feature, a part of the period corresponding to the data area is not allocated to the user data.

In the first feature, the period corresponding to an area allocated to the user data is contiguous to the period corresponding to the control area.

In the first feature, in the case where a part of the period corresponding to the data area is allocated to control information necessary for radio communications, the period corresponding to an area allocated to the user data is the period corresponding to the data area including the period corresponding to the area allocated to the control information.

A radio base station (radio base station eNB10-1) according to a second feature, in a radio communication system (radio communication system 1) having a plurality of radio resources corresponding to different frequency bands, allocates the radio resources to a radio terminal. The radio base station comprises: transmitters (radio communication unit 110-1, radio communication unit 110-2) provided for each of the different frequency bands and sending, to the radio terminal, a radio signal at the corresponding frequency band using the allocated radio resource; and a controller (power supply controller 128) controlling power supplies of the transmitters. The controller turns off the transmitter which sends the radio signal at the frequency band for an unallocated radio resource among the radio resources.

According to the above feature, the controller is capable of turning off the transmitter for a frequency band for an unallocated radio resource, i.e., a frequency band where no radio communication is performed between the radio base station and the radio terminal. This enables efficient power supply control.

In the second feature, the transmitter includes a signal amplifier (power amplifier 112) amplifying a transmitting power, and the controller turns off the signal amplifier.

In the second feature, the transmitter includes a signal amplifier amplifying a transmitting power, and the controller turns off the signal amplifier.

A power supply control method according to a third feature is a method for a radio base station, in a radio communication system having a plurality of radio resources corresponding to different periods, allocating the radio resources to a radio terminal. The power supply control method comprises the step of controlling a power supply of a transmitter. The transmitter sends, to the radio terminal, a radio signal using the allocated radio resources. In the control step, the transmitter is turned off in a period corresponding to an unallocated radio resource among the radio resources.

A power supply control method according to a fourth feature is a method for a radio base station, in a radio communication system having a plurality of radio resources corresponding to different frequency bands, allocating the radio resources to a radio terminal. The power supply control method comprises the step of controlling power supplies of transmitters. The transmitters are provided for each of the different frequency bands and send, to the radio terminal, a radio signal at the corresponding frequency band using the allocated radio resource. In the control step, the transmitter which sends the radio signal at the frequency band for an unallocated radio resource among the radio resources is turned off.

### BRIEF DESCRIPTION OF THE DRAWINGS

FIG. 1 is a diagram for describing the outline of a LTE system.

FIG. 2 is a schematic configuration diagram of a radio communication system according to the embodiment of the present invention.

FIG. 3 is a diagram showing the configuration of the radio base station according to the embodiment of the present invention.

FIG. 4 is a diagram showing an example of a downlink radio resource according to the embodiment of the present invention.

FIG. 5 is a flowchart showing the operation of the radio base station according to the embodiment of the present invention.

FIG. 6 is a block diagram showing another configuration of the radio base station according to the embodiment of the present invention.

### DESCRIPTION OF THE EMBODIMENTS

Next, with reference to the drawings, an embodiment of the present invention will be described. Specifically, s description is given of (1) Outline of LTE System, (2) Configuration of Radio Communication System, (3) Configuration of Radio Base Station, (4) Operation of Radio Base Station, (5) Operation and Effect, and (6) Other Embodiments. In the drawings of the embodiments, the same or similar reference signs are applied to the same or similar parts.

(1) Outline of LTE System

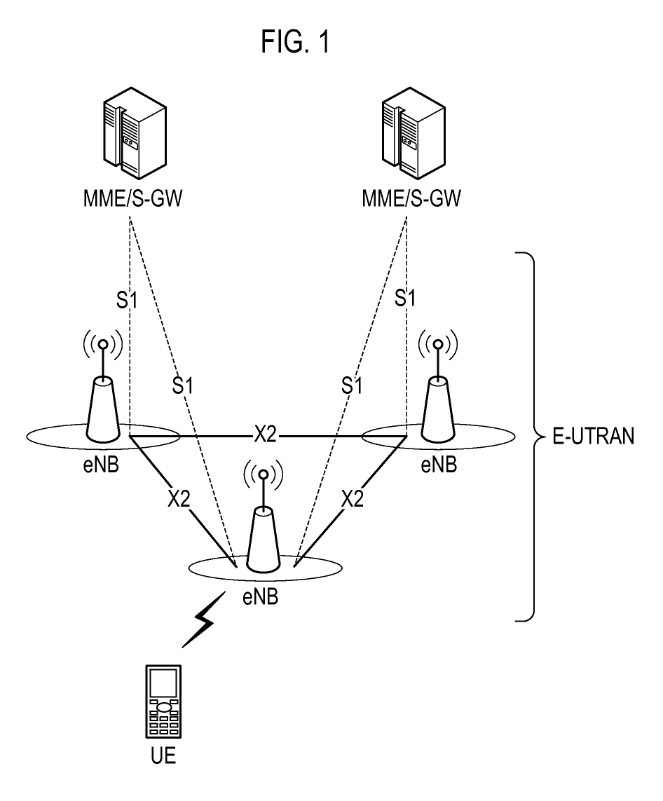

FIG. 1 is a diagram for describing the outline of a LTE system. As shown in FIG. 1, multiple radio base stations eNB constitute E-UTRAN (Evolved-UMTS Terrestrial Radio Access Network). Each of the multiple radio base stations eNB forms a cell being a communication area in which a service should be provided to radio terminals UE.

A radio terminal UE is a radio communication device held by the user and is also called user equipment. The radio terminal UE measures the quality of a radio signal (i.e., radio quality) received from each radio base station eNB, and sends, to its connection target radio base station eNB, a report on the measurement result of the radio quality (hereinafter measurement result report).

Examples of the radio quality include the reference signal received power (RSRP) and the signal to interference plus noise ratio (SINR). A measurement result report regarding RSRP is called a measurement report, whereas a measurement result report regarding SINR index is called a CQI (Channel Quality Indicator).

In addition, the connection target radio base station eNB for the radio terminal UE allocates resource blocks to the radio terminal UE on the basis of a CQI received from the radio terminal UE, each of the resource blocks being the unit of allocation of radio resources.

The radio base stations eNB can communicate with each other via an X2 interface which is a logical communication channel for providing communications between the base stations. Each of the multiple radio base stations eNB can communicate with the EPC (Evolved Packet Core), more specifically, with the MME (Mobility Management Entity)/S-GW (Serving Gateway) via an S1 interface.

(2) Configuration of Radio Communication System

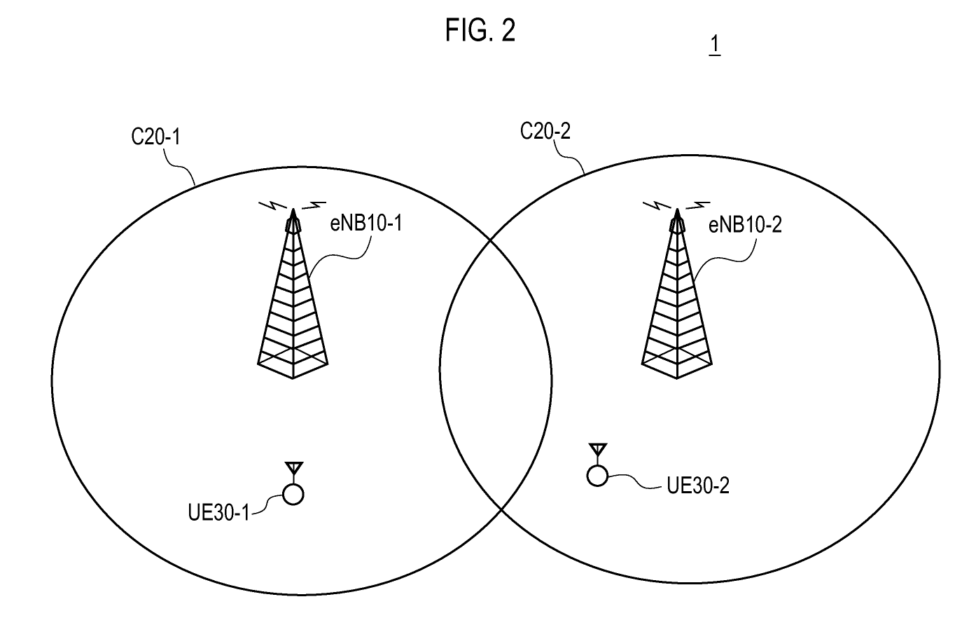

FIG. 2 is a schematic configuration diagram of a radio communication system 1 according to this embodiment.

As shown in FIG. 2, the radio communication system 1 includes: a radio base station eNB10-1 forming a cell C20-1; a radio base station eNB10-2 forming a cell C20-2; a radio terminal UE30-1 in the cell C20-1; and a radio terminal UE30-2 in the cell C20-2. The radio base station eNB10-1 and the radio base station eNB10-2 can perform communications with each other using the X2 interface described above. In addition, the radio base station eNB10-1 performs radio communications with the radio terminal UE in the cell C20-1, and the radio base station eNB10-2 performs radio communications with the radio terminal UE30-2 in the cell C20-2.

Note that, although only one radio terminal UE30-1 and only one radio terminal UE30-2 are shown in FIG. 2, there are two or more radio terminals UE30-1 and two or more radio terminals 30-2 in the practical case.

(3) Configuration of Radio Base Station

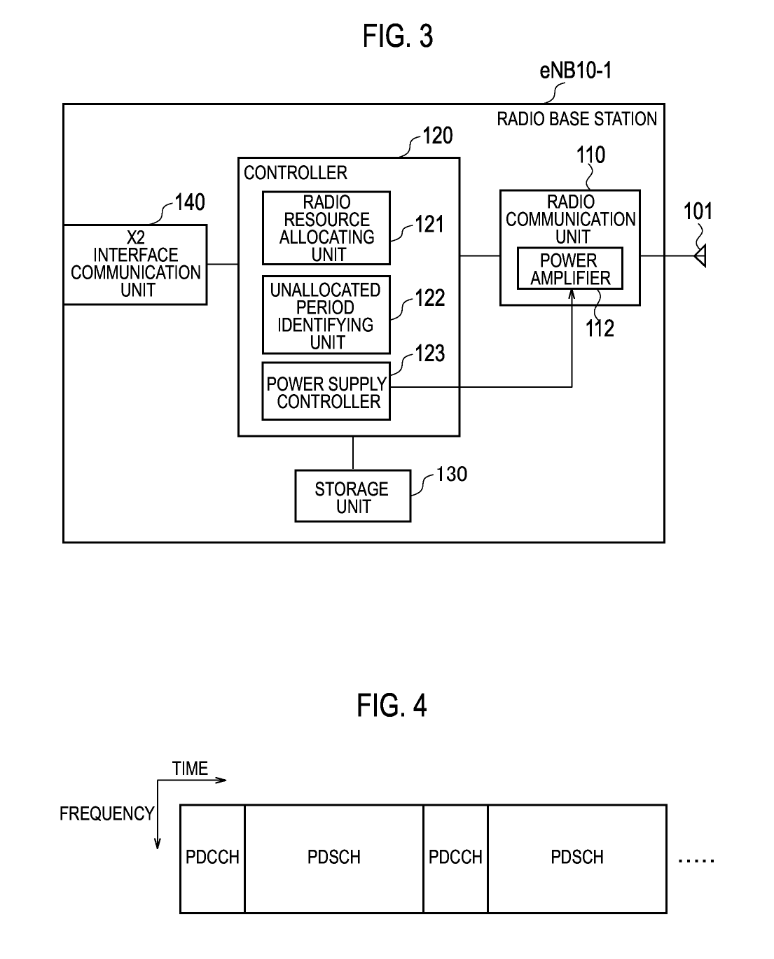

Next, the configuration of the radio base station eNB10-1 is described. FIG. 3 is a block diagram showing the configuration of the radio base station eNB10-1 according to this embodiment. Note that the radio base stations eNB10-1 and eNB10-2 have the same configuration.

As shown in FIG. 3, the radio base station eNB10-1 includes: an antenna 101; a radio communication unit 110; a controller 120; a storage unit 130; and an X2 interface communication unit 140.

The antenna 101 is used for exchanging radio signals with the radio terminal UE30-1.

The radio communication unit 110 includes a radio frequency (RF) circuit, a baseband (BB) circuit, and the like, for example, and exchanges radio signals with the radio terminal UE30-1 through the antenna 101. The radio communication unit 110 also modulates a sending signal and demodulates a received signal. The radio communication unit 110 includes a power amplifier 112. The power amplifier 112 amplifies a sending signal and outputs the amplified sending signal to the antenna 101.

The controller 120 includes a CPU, for example, and controls various functions that the radio base station eNB10-1 has. The storage unit 130 includes a memory, for example, and stores various kinds of information used for, for example, control performed by the radio base station eNB10-1. The X2 interface communication unit 140 performs inter-base station communications with the radio base station eNB10-2 using the X2 interface.

The controller 120 includes: a radio resource allocating unit 121; an unallocated period identifying unit 122; and a power supply controller 123.

The radio resource allocating unit 121 allocates resource blocks as radio resources to the radio terminal UE30-1 in the cell C20-1 on the basis of a CQI received from the radio terminal UE30-1.

FIG. 4 is a diagram showing resource blocks which are downlink (a direction from the radio base station eNB10-1 toward the radio terminal UE30-1) radio resources allocatable to the radio terminal UE30-1. The resource blocks are arranged continuously in the time direction. The multiple resource blocks continuous in the time direction constitute one radio frame.

One resource block has a time length equal to that of two sub frames. Each resource block includes: a control information channel (PDCCH: Physical Downlink Control CHannel) used for transmitting downlink control information; and a shared data channel (PDSCH: Physical Downlink Shared CHannel) used for transmitting downlink user data, which are arranged in the time direction.

In the allocation of resource blocks to the radio terminal UE30-1 by the radio resource allocating unit 121, among PDCCH and PDSCH in each resource block, allocating PDCCH to the radio terminal UE30-1 is essential but allocating PDSCH thereto is optional. For this reason, in terms of one resource block, there is sometimes a case where PDCCH is allocated but no PDSCH is allocated. In other words, a period corresponding to PDSCH in each resource block can be an unallocated period.

The unallocated period identifying unit 122 monitors how the radio resource allocating unit 121 allocates PDSCH to the radio terminal UE30-1 and identifies a period corresponding to an area of PDSCH not allocated to the radio terminal UE30-1 (hereinafter PDSCH unallocated period). The PDSCH unallocated period is identified uniquely by information on the temporal position of a start timing of the unallocated PDSCH based on a start timing of one radio frame, and the time length of the unallocated PDSCH.

The power supply controller 123 controls a power supply of the power amplifier 112 in the radio communication unit 110.

Specifically, the power supply controller 123 monitors a period of time elapsed after a start timing of one radio frame when the radio base station eNB10-1 and the radio terminal UE30-1 allocated with resource blocks perform radio communications using the resource blocks.

The power supply controller 123 judges that a PDSCH unallocated period arrives when the period of time elapsed after the start timing of one radio frame matches the temporal position of a start timing of an unallocated PDSCH. In this case, the power supply controller 123 performs control to turn off the power amplifier 112. With this control, the power amplifier 112 becomes inactive.

Further, the power supply controller 123 judges that the PDSCH unallocated period is over when a period of time indicated by the time length of the unallocated PDSCH passes after the arrival of the PDSCH unallocated period. In this case, the power supply controller 123 performs control to turn on the power amplifier 112. With this control, the power amplifier 112 starts amplifying a sending signal again.

(4) Operation of Radio Base Station

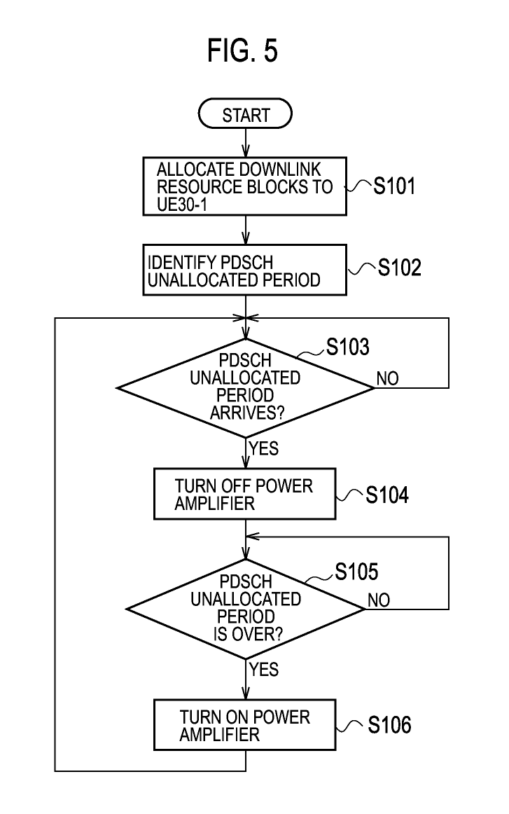

FIG. 5 is a flowchart showing the operation of the radio base station eNB10-1 according to this embodiment. Note that the power amplifier 112 is initially in an ON state.

In Step S101, the radio resource allocating unit 121 of the controller 120 allocates downlink resource blocks as radio resources to the radio terminal UE30-1 in the cell C20-1.

In Step S102, the unallocated period identifying unit 122 of the controller 120 identifies a period corresponding to an area of unallocated PDSCH (PDSCH unallocated period).

In Step S103, the power supply controller 123 of the controller 120 judges whether or not the PDSCH unallocated period arrives when the radio base station eNB10-1 and the radio terminal UE30-1 allocated with the resource blocks perform radio communications using the resource blocks.

If the PDSCH unallocated period arrives, in Step S104, the power supply controller 123 of the controller 120 performs control to turn off the power amplifier 112.

In Step S105, the power supply controller 123 of the controller 120 judges whether or not the PDSCH unallocated period is over.

If the PDSCH unallocated period is over, in Step S106, the power supply controller 123 of the controller 120 performs control to turn on the power amplifier 112 again. Thereafter, the operations in and after Step S103, in which whether or not the PDSCH unallocated period arrives is judged, are iterated.

(5) Operation and Effect

As described above, according to this embodiment, if an unallocated PDSCH exists upon allocating downlink resource blocks to the radio terminal UE30-1, the radio base station eNB10-1 identifies a period corresponding to an area of the unallocated PDSCH (PDSCH unallocated period), and performs control to turn off the power amplifier 112 in the PDSCH unallocated period.

Accordingly, the power amplifier 112 is turned off in the period corresponding to the area of the unallocated PDSCH, i.e., in a period where no radio communication is performed between the radio base station eNB10-1 and the radio terminal UE30-1.

Thus, it is possible to control the power supply of the radio base station eNB10-1 efficiently without interrupting radio communications. Moreover, since the power amplifier 112 consumes much power, the turning off of the power amplifier 112 enables effective reduction of power consumed by the radio base station eNB10-1.

(6) Other Embodiments

Although the present invention has been described using the foregoing embodiment, it should not be understood that descriptions and drawings constituting a part of this disclosure limit the present invention. Various alternative embodiments, examples, and operation techniques are apparent to those skilled in the art based on this disclosure.

### Other Embodiment 1

In the foregoing embodiment, description is given of the case where the whole of the period corresponding to an area of PDSCH in one resource block is not allocated. On the other hand, when a part of the period corresponding to the area of PDSCH is allocated to user data, the control over the power supply of the power amplifier 112 is carried out in the following way.

To the radio terminal UE30-1 in the cell C20-1, the radio resource allocating unit 121 allocates PDSCH and a part of PDSCH of each resource block as a radio resource, on the basis of a CQI received from the radio terminal UE30-1.

The unallocated period identifying unit 122 monitors how the radio resource allocating unit 121 allocates PDSCH to the radio terminal UE30-1 and identifies a period corresponding to a part of an area of PDSCH not allocated to the radio terminal UE (hereinafter unallocated area period). The unallocated area period is identified uniquely by information on the temporal position of a start timing of the unallocated part of the area of PDSCH based on a start timing of one radio frame, and the time length of the unallocated part of the area.

The power supply controller 123 monitors a period of time elapsed after a start timing of one radio frame when the radio base station eNB10-1 and the radio terminal UE30-1 allocated with resource blocks perform radio communications using the resource blocks.

The power supply controller 123 judges that an unallocated area period arrives when the period of time elapsed after the start timing of one radio frame matches the temporal position of a start timing of an unallocated part of an area of PDSCH. In this case, the power supply controller 123 performs control to turn off the power amplifier 112. With this control, the power amplifier 112 becomes inactive.

Further, the power supply controller 123 judges that the unallocated area period is over when a period of time indicated by the time length of the unallocated part of the area passes after the arrival of the unallocated area period. In this case, the power supply controller 123 performs control to turn on the power amplifier 112. With this control, the power amplifier 112 starts amplifying a sending signal again.

Note that, upon allocating a part of PDSCH to the radio terminal UE30-1 for user data, the radio resource allocating unit 121 may allocate, as an area for user data, a period contiguous to a period corresponding to an area of PDCCH which is allocated to predefined information such as paging information. This prevents the period corresponding to the unallocated part of the area of PDSCH from being distributed in the time direction in one resource block; instead, a period corresponding to the entire area of PDCCH and a period corresponding to an allocated part of an area of PDSCH continue in the time direction, and a period corresponding to the unallocated part of the area follows. Accordingly, what the power supply controller 123 has to do within a period corresponding to one resource block is to perform control to turn off the power amplifier 112 only once at the timing where the period corresponding to the allocated part of the area of PDSCH is shifted to the period corresponding to the unallocated part of the area of PDSCH. As a consequence, the processing load involved by the power supply control is reduced.

### Other Embodiment 2

A part of a period corresponding to an area of PDSCH is sometimes allocated to control information necessary for radio communications. Here, the control information necessary for radio communications includes a reference signal (ReferenceSignal), a broadcast channel (PBCH: Physical Broadcast CHannel), a primary synchronization signal (P-SS: Primary Synchronization Signal), and a secondary synchronization signal (S-SS: Secondary Synchronization Signal). In this case, the following processes are carried out.

Specifically, the radio resource allocating unit 121 performs allocation such that a period corresponding to an area of PDSCH allocated to the control information uses a part of a period corresponding to an area for user data. Therefore, the same PDSCH is allocated to the control information and the user data. This reduces the number of power supply control performed on the power amplifier 112 by the power supply controller 123, and thereby reduces the processing load involved by the power supply control.

### Other Embodiment 3

In each of the foregoing embodiments, the radio base station eNB10-1 performs control to turn off the power amplifier 112 in the period corresponding to the unallocated PDSCH. However, if radio communication units are provided on per frequency band basis, the radio base station eNB10-1 may identify a frequency band for an area of an unallocated radio resource, and performs control to turn off the radio communication unit which processes a radio signal at the frequency band for the area of the unallocated radio resource.

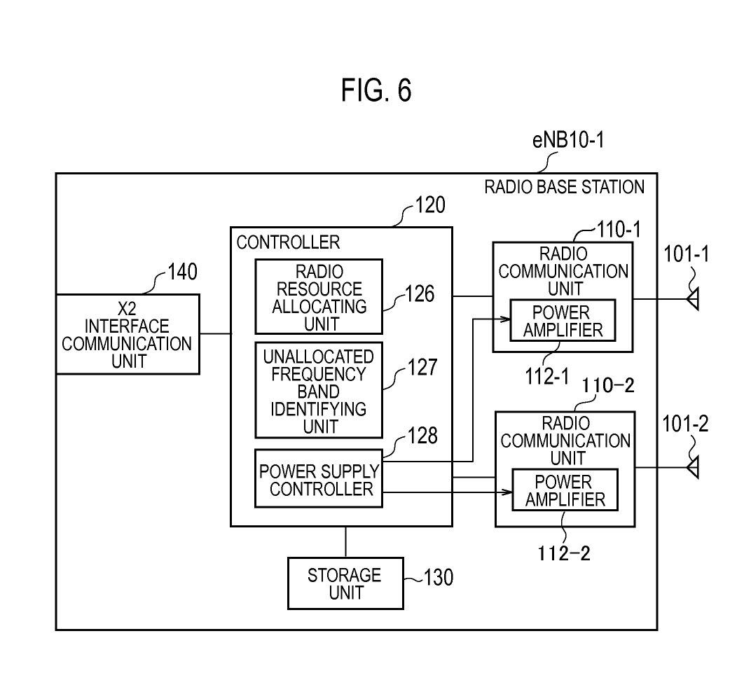

FIG. 6 is a block diagram showing another configuration of the radio base station eNB10-1 according to this embodiment. As shown in FIG. 6, the radio base station eNB10-1 includes: an antenna 101-1; an antenna 101-2; a radio communication unit 110-1; a radio communication unit 110-2; a controller 120; a storage unit 130; and an X2 interface communication unit 140.

The antenna 101-1 and the antenna 101-2 are used for exchanging radio signals with the radio terminal UE30-1.

The radio communication unit 110-1 and the radio communication unit 110-2 perform processing for exchanging radio signals at different frequency bands. For example, the radio communication unit 110-1 performs processing for exchanging radio signals of 2 GHz, whereas the radio communication unit 110-2 performs processing for exchanging radio signals of 800 MHz.

The radio communication unit 110-1 includes a radio frequency (RF) circuit, a baseband (BB) circuit, and the like, for example, and exchanges radio signals with the radio terminal UE30-1 through the antenna 101-1. The radio communication unit 110-1 also modulates a sending signal and demodulates a received signal. The radio communication unit 110-1 includes a power amplifier 112-1. The power amplifier 112-1 amplifies a sending signal and outputs the amplified sending signal to the antenna 101-1. The radio communication unit 110-2 is similar to the radio communication unit 110-1. Specifically, the radio communication unit 110-2 exchanges radio signals with the radio terminal UE30-1 through the antenna 101-2. The radio communication unit 110-2 also modulates a sending signal and demodulates a received signal. The radio communication unit 110-2 includes a power amplifier 112-2. The power amplifier 112-2 amplifies a sending signal and outputs the amplified sending signal to the antenna 101-2.

The controller 120 includes a CPU, for example, and controls various functions that the radio base station eNB10-1 has. The controller 120 includes: a radio resource allocating unit 126; an unallocated frequency band identifying unit 127; and a power supply controller 128.

The radio resource allocating unit 126 allocates radio resources to the radio terminal UE30-1.

The unallocated frequency band identifying unit 127 monitors how the radio resource allocating unit 126 allocates radio resources to the radio terminal UE30-1 and identifies a frequency band for a radio resource not allocated to the radio terminal UE30-1 (hereinafter unallocated frequency band).

The power supply controller 128 controls a power supply of the power amplifier 112-1 in the radio communication unit 110-1 and a power supply of the power amplifier 112-2 in the radio communication unit 110-2.

More specifically, the power supply controller 128 compares a frequency band at which the radio communication unit 110-1 can exchange signals, with the unallocated frequency band identified by the unallocated frequency band identifying unit 127, and judges whether or not the whole of the frequency band at which the radio communication unit 110-1 can exchange signals is the unallocated frequency band. In the same way, the power supply controller 128 compares a frequency band at which the radio communication unit 110-2 can exchange signals with the unallocated frequency band identified by the unallocated frequency band identifying unit 127, and judges whether or not the whole of the frequency band at which the radio communication unit 110-2 can exchange signals is the unallocated frequency band.

If the whole of the frequency band at which the radio communication unit 110-1 can exchange signals is the unallocated frequency band, the power supply controller 128 performs control to turn off the power amplifier 112-1 of the radio communication unit 110-1. In the meantime, if the whole of the frequency band at which the radio communication unit 110-2 can exchange signals is the unallocated frequency band, the power supply controller 128 performs control to turn off the power amplifier 112-2 of the radio communication unit 110-2.

This control turns off the power amplifier of the radio communication unit which exchanges radio signals at the frequency band for the unallocated radio resource. Thus, it is possible to control the power supply of the radio base station eNB10-1 efficiently without interrupting radio communications.

Note that, in the case where apart of an area of one PDSCH corresponding to a certain frequency band is not allocated and where processors, such as CPUs, forming the controller 120 are provided on per frequency band basis and these processors process information on radio signals at the frequency bands for the respective processors, the power supplies of the processors can be controlled in the following way. Specifically, if the whole of the frequency band for a certain one of the processors matches the certain frequency band corresponding to the unallocated part of the area of PDSCH, the power supply controller 128 performs control to turn off this processor.

### Other Embodiment 4

Although the LTE system has been described in the foregoing embodiments, the present invention may be applied to another radio communication system such as a radio communication system based on WiMAX (IEEE 802.16).

For example, in a communication system based on WiMAX, it is possible to allocate only a part of a period corresponding to a data area to a radio terminal. Accordingly, in the communication system based on WiMAX, the unallocated period identifying unit 122 identifies a period corresponding to an unallocated area in the data area (unallocated area period). In addition, when the period of time elapsed after the start timing of one radio frame matches the temporal position of a start timing of the period corresponding to the unallocated area in the data area, the power supply controller 123 judges that the unallocated area period arrives and performs control to turn off the power amplifier 112.

Further, if a period of time indicated by the time length of the unallocated area passes after the arrival of the unallocated area period, the power supply controller 123 judges that the unallocated area period is over and performs control to turn on the power amplifier 112.

As mentioned above, the present invention includes various embodiments and the like which are not described herein. Accordingly, the present invention should be limited only by the matters defining the invention described in the scope of the claims which is appropriate from this disclosure.

Note that the entire content of the Japanese Patent Application No. 2010-140008 (filed on Jun. 18, 2010) is incorporated herein by reference.

### INDUSTRIAL APPLICABILITY

According to the present invention, the radio base station and the power supply control method are provided which enable efficient power supply control.

1. A radio base station in a radio communication system having a plurality of radio resources corresponding to different periods, configured to allocate the radio resources to a radio terminal, comprising:
a transmitter configured to send, to the radio terminal, a radio signal using the allocated radio resources; and
a controller configured to control a power supply of the transmitter, wherein
the controller turns off the transmitter in a period corresponding to an unallocated radio resource among the radio resources.

2. The radio base station according to claim 1, wherein
the radio resources include a control area for control data and a data area for user data which are arranged in a time direction, and
the controller turns off the transmitter in the period corresponding to an unallocated data area among the data areas of the radio resources.

3. The radio base station according to claim 2, wherein a part of the period corresponding to the data area is not allocated to the user data.

4. The radio base station according to claim 3, wherein the period corresponding to an area allocated to the user data is contiguous to the period corresponding to the control area.

5. The radio base station according to claim 3, wherein, in the case where a part of the period corresponding to the data area is allocated to control information necessary for radio communications, the period corresponding to an area allocated to the user data is the period corresponding to the data area including the period corresponding to the area allocated to the control information.

6. A radio base station in a radio communication system having a plurality of radio resources corresponding to different frequency bands, configured to allocate the radio resources to a radio terminal, comprising:
transmitters provided for each of the different frequency bands and configured to send, to the radio terminal, a radio signal at the corresponding frequency band using the allocated radio resource; and
a controller configured to control power supplies of the transmitters, wherein
the controller turns off the transmitter which sends the radio signal at the frequency band for an unallocated radio resource among the radio resources.

7. The radio base station according to any one of claims 1 to 6, wherein
the transmitter includes a signal amplifier configured to amplify a transmitting power, and
the controller turns off the signal amplifier.

8. A power supply control method for a radio base station in a radio communication system having a plurality of radio resources corresponding to different periods, the radio base station configured to allocate the radio resources to a radio terminal, comprising the step of
controlling a power supply of a transmitter, wherein
the transmitter sends, to the radio terminal, a radio signal using the allocated radio resources, and
in the control step, the transmitter is turned off in a period corresponding to an unallocated radio resource among the radio resources.

9. A power supply control method for a radio base station in a radio communication system having a plurality of radio resources corresponding to different frequency bands, the radio base station configured to allocate the radio resources to a radio terminal, comprising the step of
controlling power supplies of transmitters, wherein
the transmitters are provided for each of the different frequency bands and send, to the radio terminal, a radio signal at the corresponding frequency band using the allocated radio resource, and
in the control step, the transmitter which sends the radio signal at the frequency band for an unallocated radio resource among the radio resources is turned off.
